(19) United States
(12) Patent Application Publication
(10) Pub. No.: US 2016/0177597 A1
(43) Pub. Date: Jun. 23, 2016

(54) ANTI-SHOPLIFTING DEVICE OF THE PIN TYPE

(71) Applicant: MAINETTI S.P.A., Castelgomberto (Vicenza) (IT)

(72) Inventor: Mario Mainetti, Valdagno (Vicenza) (IT)

(73) Assignee: MAINETTI S.P.A., Castelgomberto (Vicenza) (IT)

(21) Appl. No.: 14/728,446

(22) Filed: Jun. 2, 2015

(30) Foreign Application Priority Data
Dec. 23, 2014 (IT) VI 2014A000335

(51) Int. Cl. E05B 73/00; A44B 99/00; A44B 1/28

(52) U.S. Cl. CPC E05B 73/0017; A44B 1/28; A44B 99/00; E05B 73/0052; E05B 73/0064; E05B 2047/0072

(57) ABSTRACT

An anti-shoplifting device of the pin type for clothing and includes a first closure element, commonly known as “nail”, made up of a head from which a pin projects and a second closure element of a locking plate. Such two elements are held together when the pin is inserted in the locking plate, after the pin has already been inserted in the product to be protected. In the first element, the pin is contained inside a hollow shell, the pin being able to rotate from a position totally contained in the shell to a position projecting from the base of the shell and vice-versa.

### BACKGROUND OF THE INVENTION

1. Field of the Invention

The present invention concerns an anti-shoplifting device of the pin type that can be widely used, in particular, in the field of clothing.

2. Discussion of the Related Art

Among the various anti-shoplifting devices there are those commonly referred to as being of the “pin” type, which are widely used, in particular, in the field of clothing.

Such devices consist of two elements substantially in the form of a first closure element commonly called “nail”, made up of a head from which a pin projects and a second closure element, consisting of a locking plate, the two elements being held together when the pin is inserted in a locking plate after it has been inserted in the product to be protected.

Basically, a minimal portion of the fabric, of the cloth or of another product on which the anti-shoplifting device is applied is sandwiched and locked between the pin-carrying head and the locking plate of the pin inserted in it.

The end of the pin is held and locked inside the plate through electromechanical or magnetic anti-withdrawal means which can only be withdrawn through special magnetic or radio frequency devices, possessed exclusively by authorised staff, for example the cashiers of shops selling products equipped with the aforementioned anti-shoplifting device.

In practice, such types of anti-shoplifting devices, due to the presence of the pin, have the drawback of being dangerous for those tasked with handling them, for example for those tasked with applying them on the items of clothing in workshops, for cashiers who have to remove the anti-shoplifting device at the time of sale of the single item of clothing, for those who collect and transport the nails and the plates, which are collected loose and deposited in containers.

In order to give the idea of how serious such a drawback is it should be remembered that anti-shoplifting devices of the pin type, used in large quantities in clothes packages, are recycled many times over, even up to six times and their use extends, in the current globalised market, practically to all nations around the world.

As an example, the operation of applying the anti-shoplifting device onto items of clothing is carried out in the products very often manufactured in the Far East; the operation of opening and withdrawing the anti-shoplifting device from each item of clothing sold generally takes place in the West, whereas the warehouses for collecting the nails and the plates from the locations at which the products are sold are spread over the various nations of Europe and America, from where they are sent on, collected in crates, to the nations of the Far East to be applied once again onto other items of clothing in the production step.

An attempt to limit the risk of cuts or lesions, which are frequent, in particular, due to the speed with which the packagers and sales staff handle such devices, consists of making the point of the pin less sharp, but this makes it more difficult for it to penetrate, in particular into items of clothing made from compact fabric or leather.

In the current state of the art anti-shoplifting devices have been made, which tend to avoid the risks of cuts and punctures to workers, by foreseeing systems for covering the pin when it is not in use.

A first system foresees that the pin, when it is not in use, be covered by a telescopic sheath that extends from the head of the pin until it is totally covered and contained (for example we quote patent document WO 2012/020105 A1).

A further system foresees, on the other hand, that the pin, when it is not in use, be withdrawn, sliding axially, until it is totally contained inside a head (for example we quote patent document WO 01/29354 A1).

Such two different ways of operating, whilst performing their task, do not ensure the total safety of the worker, since, as the pin is always arranged coaxial with the parts that contain it, i.e. perpendicular to the base where the exit hole thereof is present, there is always the possibility of mutual sliding between the two parts (pin/telescopic cover or pin/head), caused, for example, by an accidental squashing maneuver, which leads to the top of the pin coming out, even minimally, from the hole, which compromises the safety that is required in handling such an object.

### SUMMARY OF THE INVENTION

The purpose of the present invention is to make an anti-shoplifting device of the “pin” type that does not have the drawbacks of similar known products.

Specifically, the purpose of the invention is to make an anti-shoplifting device of the “pin” type, which is totally safe to handle when it is in non-use configuration, or when the pin is disengaged from its locking plate.

A further purpose of the invention is to make an anti-shoplifting device of the “pin” type able to be made with known construction systems and with low costs.

These and other purposes of the invention, which shall become clearer hereafter, are accomplished by making an anti-shoplifting device of the “pin” type, which is characterised in that, when it is not in use, the pin is held inside a hollow shell, arranged in a condition substantially parallel to the base of the shell and rotated by about 90° with respect to the condition of the pin in the use condition; in other words, when the pin projects perpendicularly to the base of the shell, suitable for being made to penetrate into the corresponding locking plate.

The invention also foresees that the pin, when it is arranged in the two mutually perpendicular positions (conventionally in the “horizontal” position, when it is contained in the head and in the “vertical” position, when it projects from the head) be held in the two distinct positions through members that exert a contrast action to the rotation movement of the pin.

Such a contrast action exerted on the pin contained in the head ensures that the pin remains inside the head until an external intervention, deliberately performed by the worker, unlocks the pin, overcoming the contrast force that holds it and makes it rotate by 90°, so as to project from the containment head only if necessary (to be specific only at the moment of application of the anti-shoplifting device onto the garment).

Moreover, the contrast action exerted on the pin when it projects ensures that the pin remains in such a position while passing through the garment, which allows its precise insertion in the hole of the locking plate.

Similarly, the contrast action exerted on the pin when it projects means that the rotation of the pin for its reinsertion in the containment head is possible only as a consequence of an intervention deliberately performed by the worker (to be specific at the moment of detachment of the anti-shoplifting device from the garment).

Constructively, the invention is characterised in that it foresees that the pin be equipped on the end opposite the sharp tip of a pin that fits onto the base of the head, configured according to a shell equipped on the aforementioned base with an opening for the passage of the pin.

Again on the end of the pin and coaxially with it a cam is formed, which acts on a contrast element, which holds the pin in its two extreme positions, i.e. when it is contained in the head and when it projects from the head itself.

Operatively, the movement operation, with the rotation by 90° of the pin, from the “horizontal” withdrawn position, to the “vertical” projecting position, takes place manually, by acting directly on the pin, or through intermediate control members.

Specifically, in the simplest embodiment, the worker, through a slit made on the base of the containment shell of the pin, fastens the pin and, overcoming the contrast force, rotates it by 90°and in such a new position, projecting from the base, the pin remains waiting to be applied on the garment to be protected.

In a more complex embodiment, required when it is necessary to ensure the total safety of the worker, the rotation of the pin takes place by pressing a button, projecting from the outer wall of the containment head of the pin.

In particular, the action of the button acts on the pin so that the pin projects only when the worker holds the button pressed; on the other hand, when the worker releases the button, the pin automatically returns into the containment shell.

### BRIEF DESCRIPTION OF THE INVENTION

The invention will be defined more clearly through the description of some possible embodiments thereof, given only as non-limiting examples, with the help of the attached tables of drawings, where:

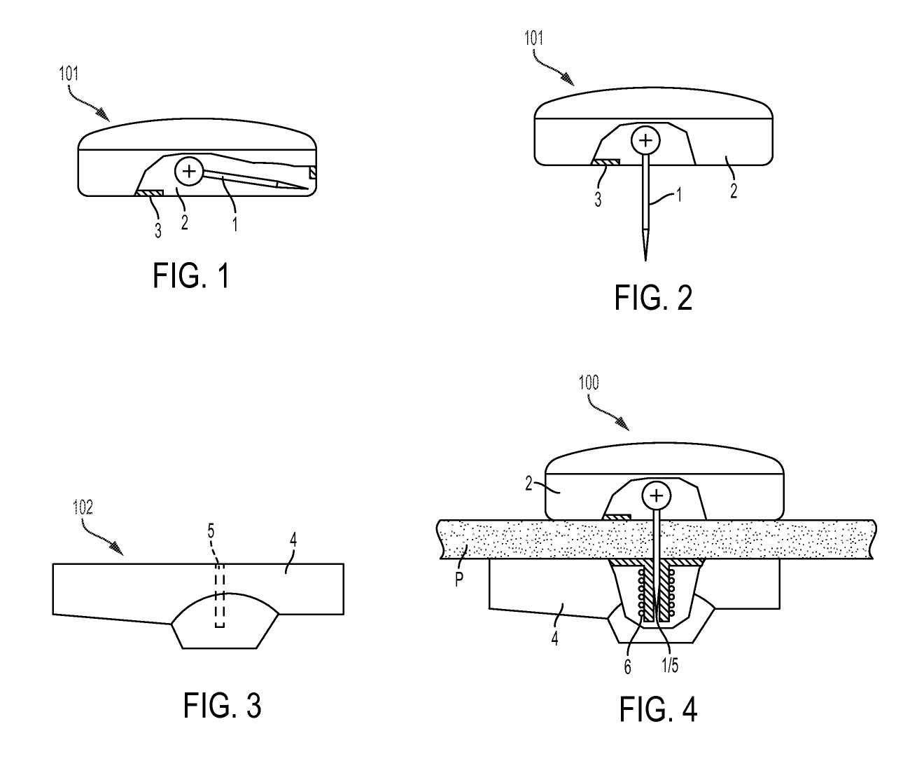

FIGS. 1-4 represent schematic views of the anti-shoplifting device according to the invention in configurations not in use and in use;

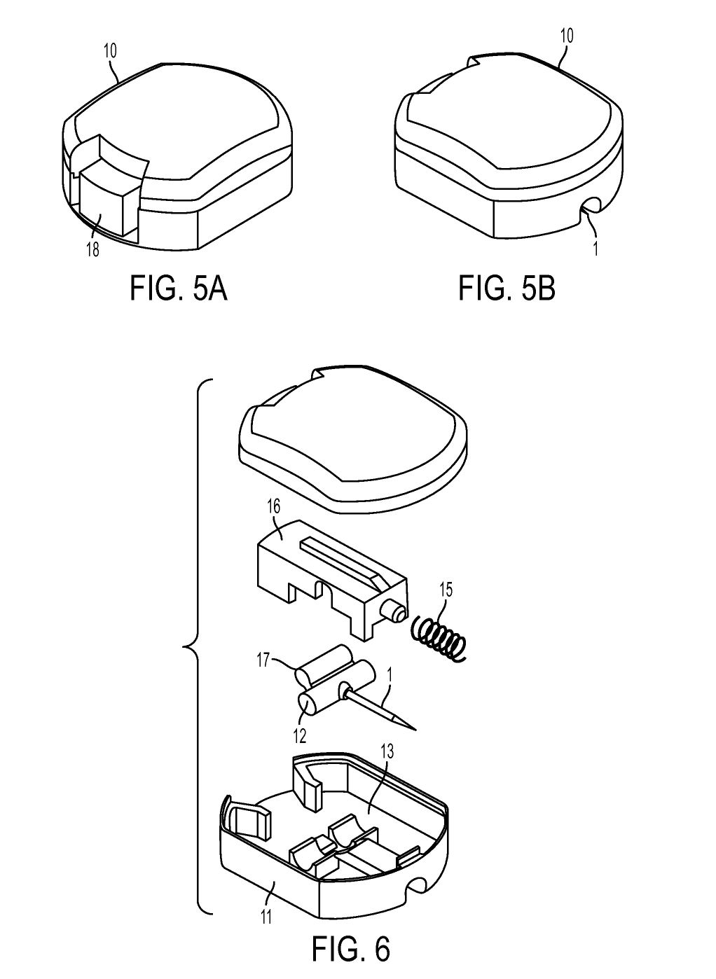

FIGS. 5a, 5b, 6, 7a, 7b, 7c, 8a, 8b, 9a, and 9b represent views of a first embodiment of the invention;

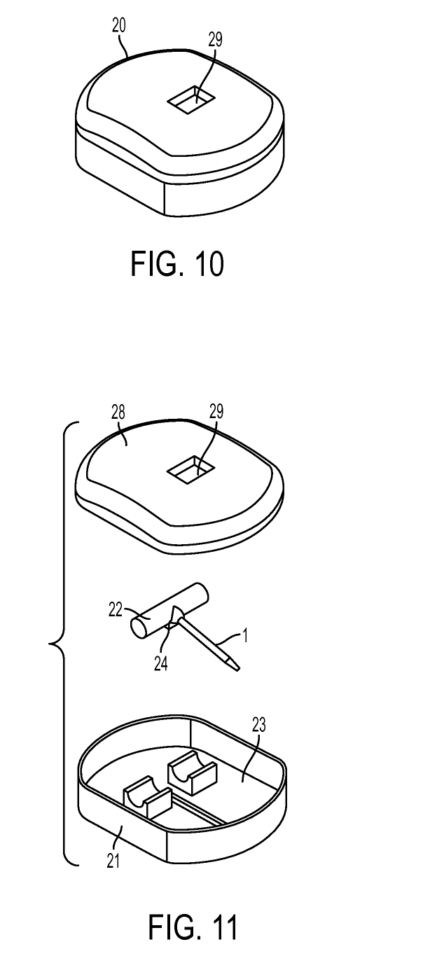

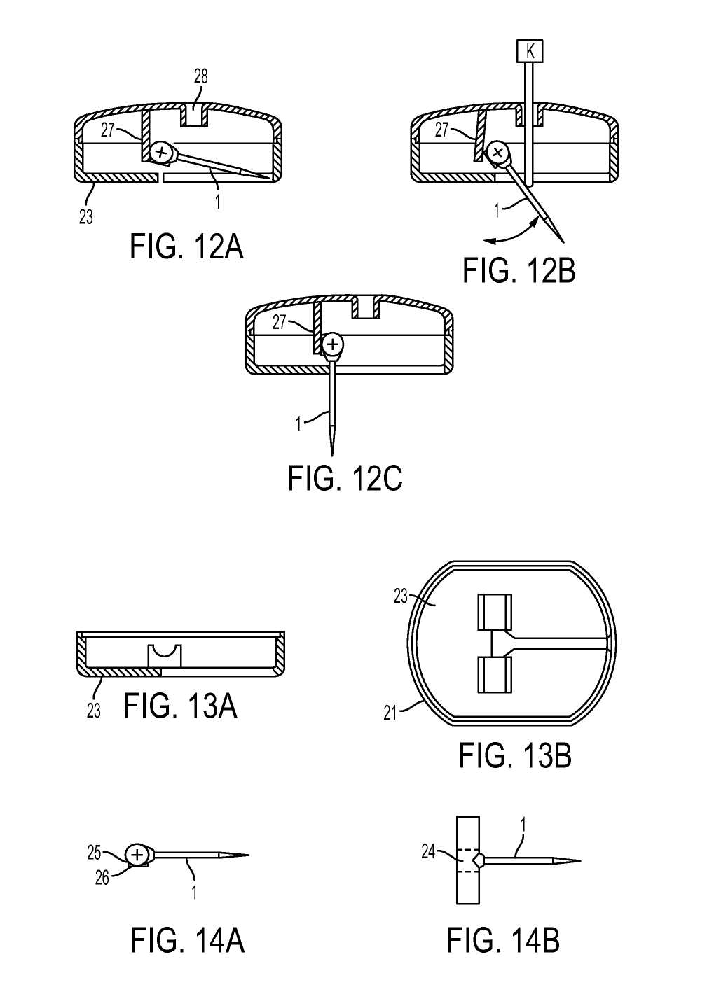

FIGS. 10, 11, 12a, 12b, 12c, 13a, 13b, and 14a, 14b represent views of a second embodiment of the invention;

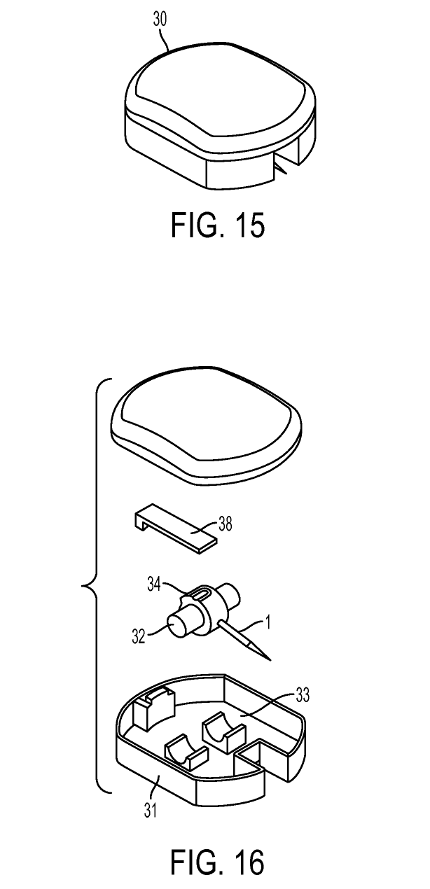

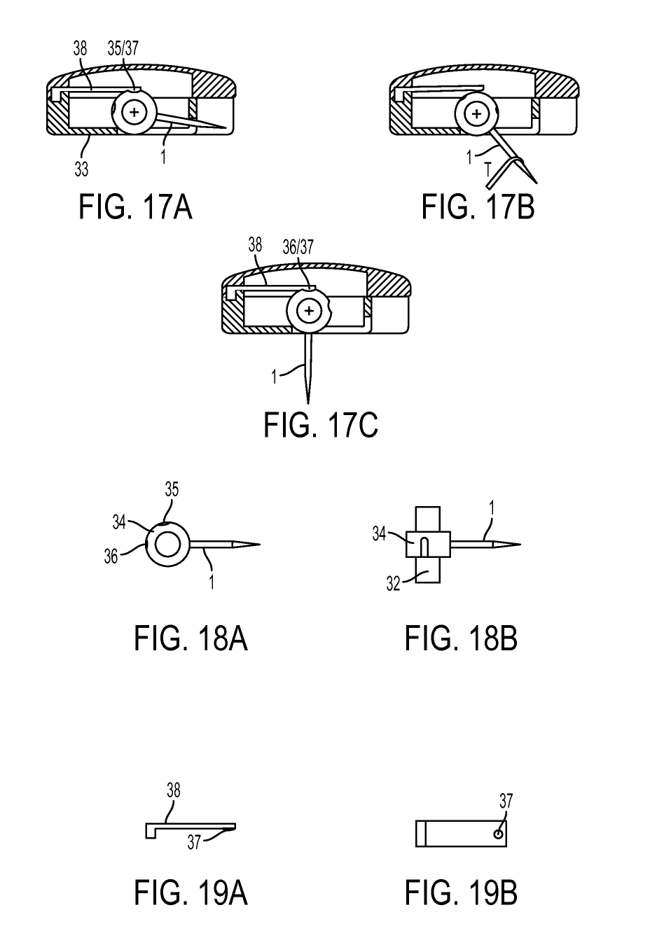

FIGS. 15, 16, 17a, 17b, 17c, 18a, 18b, and 19a, 19b represent views of a third embodiment of the invention; and

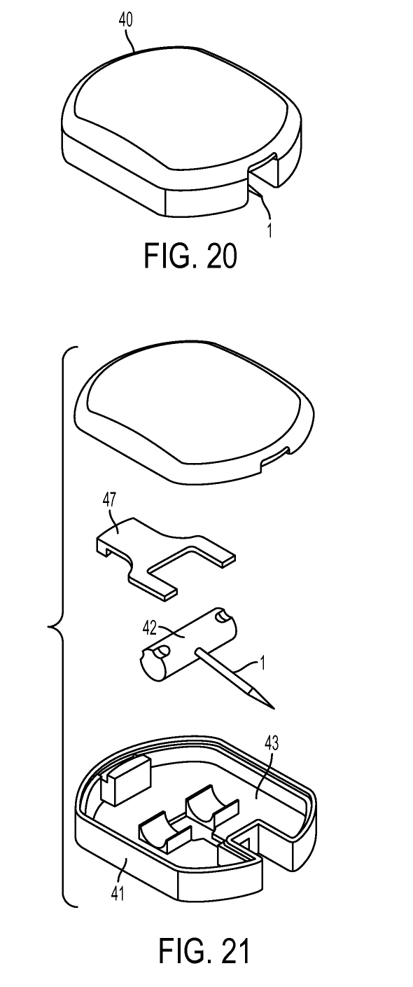

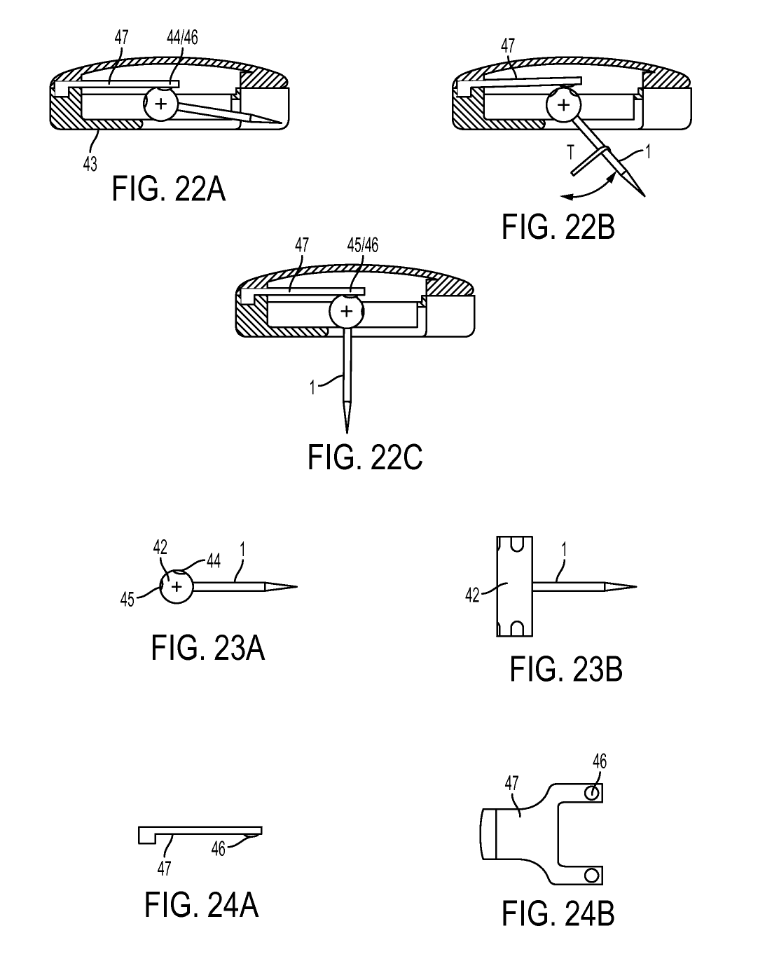

FIGS. 20, 21, 22a, 22b, 22c, 23a, 23b, 24a and 24b represent views of a fourth embodiment of the invention.

### DETAILED DESCRIPTION OF THE INVENTION

As can be seen in FIGS. 1-4, the anti-shoplifting device, wholly indicated with reference numeral 100, consists of two elements: a first element, called closing element, wholly indicated with reference numeral 101 and a second element, called locking element, wholly indicated with reference numeral 102.

The first element 101 comprises a pin 1, contained inside a hollow shell 2, where the pin 1 is able to rotate from a position totally contained in the shell (FIG. 1) to the position projecting from the base 3 of the shell and vice-versa (FIG. 2).

The second element 102 consists of a plate 4 equipped with a hole 5 (FIG. 3).

The two elements 101 and 102 are held together when the pin 1 is inserted in the locking plate 4, after the pin has been inserted in the product to be protected “P”.

Operatively, when the first element 101 is not in use, the pin 1 is held totally inside the hollow shell 2, arranged in a condition substantially parallel to the base 3 of the shell 2 (FIG. 1) whereas, on the other hand, when the first element 101 is in use, the pin 1 is positioned rotated by 90° with respect to the condition not in use, projecting perpendicularly to the base 3 of the shell 2, suitable for being brought to penetrate in the hole 5 of the corresponding locking plate 4, where it is held by anti-withdrawal means 6 (FIG. 4).

As can be seen in FIGS. 5a-9b, a first embodiment foresees that in the first element, wholly indicated with reference numeral 10, the pin 1, contained inside the shell 11, be fitted with the head peg 12 to the base 13 and be moved through an elastic member 14, consisting of a spring 15, which acts in contrast to a slider 16, the slider 16 fastening on to a pawl 17, projecting from the aforementioned head peg 12.

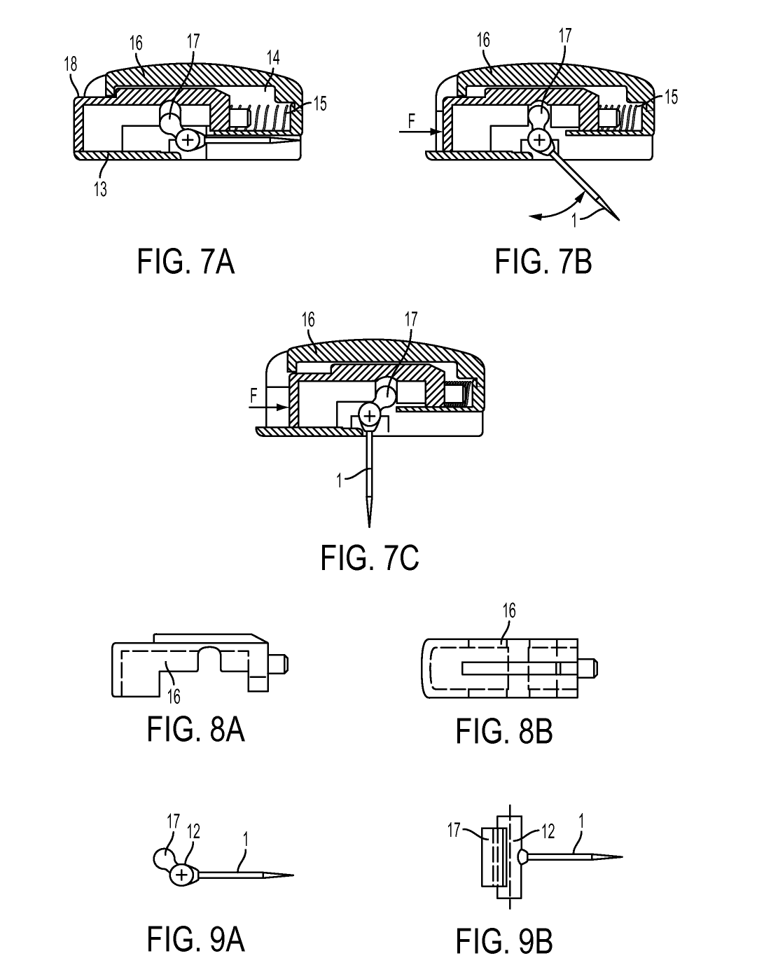

Operatively, as can be seen in the succession of FIG. 7, in the condition of non-use of the element 10 the spring 15 keeps the slider 16 pointing outward and projecting from the shell 11 so that the pin 1, through the effect of the fastening with the pawl 17, remains positioned totally contained inside the shell, arranged substantially parallel to the base 13 (see pos. “A”).

On the other hand, in the condition of use of the element 10, the operator exerts a thrust “F” from the outside onto the outer button 18, to make the slider 16 slide inwards, which, consequently, through the effect of the fastening with the pawl 17, results in the rotation by 90° of the pin 1 (see pos. “B”-“C”), ready to be inserted into the product “P” and into the plate 4.

In practice, the advantage of use of the element 10 consists of the fact that the pin 1, through the effect of the elastic member 14, automatically withdraws into the shell 11.

Basically, when the worker detaches the anti-shoplifting device 100 from the product “P”, the pin 1 immediately and automatically withdraws into the closure element 101/10, as soon as it is separated from the plate 4, so as to be able to obtain the total safety of the worker, when he/she has to handle the device.

As can be seen in FIGS. 10-14b, a second embodiment foresees that in the first element, wholly indicated with reference numeral 20, the pin 1, contained inside the shell 21, be equipped with a head peg 22, fitted to the base 23 and has, in a central position, a cam 24, consisting of two walls 25 and 26, which rest, alternatively, against an elastic contrast lamella 27, projecting inside the cover 28 of the shell 20, so as to hold the pin contained totally inside the shell (see pos. “A”) or, with a rotation by 90°, projecting from the base 23 (see pos. “B”-“C”).

In practice the worker, through a slit 29 made on the cover 28, through a tool “K”, pushes the pin 1, held inside the shell 21 by the wall 25, which goes into abutment against the lamella 27, so as to rotate it to the position projecting from the base 23, where it remains held through the effect of the wall 26, which goes into abutment against the lamella 27.

As can be seen in FIGS. 15-19b, a third embodiment foresees that in the first element, wholly indicated with reference numeral 30, the pin 1, contained inside the shell 31, is equipped with a head peg 32, fitted to the base 33 and has, in a central position, a cam 34 consisting of two notches 35 and 36, which, alternatively, engage with a corresponding indentation 37 present at the end of an elastic contrast lamella 38, positioned inside the shell 30, so as to hold the pin 1 totally contained inside the shell (see pos. “A”) or, with a rotation by 90°, projecting from the base 33 (see pos. “B”-“C”).

In practice, the worker, through a tool “T”, hooks onto the pin 1, held inside the shell by the interlocking of the indentation 37 in the notch 35 (pos. “A”), so as to rotate it to the position projecting from the base 33, where it remains held through the effect of the interlocking of the indentation 37 with the notch 36.

As can be seen in FIGS. 20-24b, a fourth embodiment, simplified with respect to the embodiment described earlier, foresees that in the first element, wholly indicated with reference numeral 40, the pin 1, contained inside the shell 41, be equipped with a head peg 42, fitted to the base 43, which has two pairs of notches 44 and 45 on its surface, which, alternatively, engage with two corresponding pairs of indentations 46 and 47, present on an elastic contrast fork 48, positioned inside the shell 40, so as to hold the pin 1 contained totally inside the shell (see pos. “A”) or, with a rotation by 90°, projecting from the base 43 (see pos. “B”-“C”).

Of course, embodiments different from those described are also possible, provided that they are all covered by the inventive concept defined by the following claims.

1. An anti-shoplifting device to prevent theft of a product; the anti-shoplifting device comprising:
a first closure element comprising a shell, a head, and a pin,
the shell being hollow and comprising a base,
the pin projecting from the head, the pin for passing through the product,
the pin rotating from a first position projecting from the base;
a second closure element comprising a locking plate having an electromechanical anti-withdrawal means or a magnetic anti-withdrawal means; and
the first closure element and the second closure element being held together when the pin is inserted in the locking plate, an end of the pin being locked inside the locking plate by the respective anti-withdrawal means, the anti-withdrawal means being defeatable through a special magnetic device or a radio frequency device.

2. The anti-shoplifting device of claim 1, wherein
when the first closure element is not in use, the pin is in the first position;
when the first closure element, is in use, the pin is in the second position;
wherein in the first position, the pin is held entirely inside the hollow shell substantially parallel to the base, and
wherein the second position differs from the first position by rotating the pin by 90° from being parallel to the base.

3. The anti-shoplifting device of claim 2,
further comprising intermediate control members acting on the pin.
wherein when rotating the pin from the first position to the second position occurs the intermediate control members whereas, on the other hand, the pin automatically withdraws into intermediate control members whereas, on the other hand, the pin automatically withdraws into the shell when the operator releases the control member.

4. The anti-shoplifting device of claim 3,
further comprising a spring, a slider, and a base pawl joined to the base, the slider comprising a user-activated button;
wherein the head comprises a head peg and a head pawl, the head pawl projecting from the head peg;
wherein in the first position the slider is biased by the spring to fasten the slider onto the head pawl to be parallel to the base pawl;
wherein in the second position, a user applied force on the button overcomes biasing of the spring to slide the slider inwards permitting rotation of the pin from the second position to the first position.

5. The anti-shoplifting device of claim 2, wherein rotating the pin is performed manually.

6. An anti-shoplifting device to prevent theft of a product; the anti-shoplifting device comprising:
a first closure element comprising a shell, a head, and a pin,
the shell defining an interior space, the shell comprising a base, a lamella attached to the shell, and an opening providing access to the interior space;
the pin projecting from the head, the pin for passing through the product,
the head comprises a head peg and a head cam, the head being rotatably fitted to the base and being constrained by the lamella;
the pin rotating on the head cam from a first position where the pin is contained entirely in the shell to a second position projecting from the base;
a second closure element comprising a locking plate having an electromechanical anti-withdrawal means or a magnetic anti-withdrawal means; and
the first closure element and the second closure element being heid together when the pin is inserted in the locking plate, an end of the pin being locked inside the locking plate by the respective anti-withdrawal means, the anti-withdrawal means being defeatable through a special magnetic device or a radio frequency device;
wherein the pin is accessible through the opening by a user to rotate from the first position to the second position.

7. An anti-shoplifting device to prevent theft of a product; the anti-shoplifting device comprising:
a first closure element comprising a shell a head, and a pin,
the shell defining an interior space, the shell comprising a base, a lamella attached to the shell;
the pin projecting from the head, the pin for passing through the product,
the head comprises a head peg, the head being rotatably fitted to the base and being constrained by the lamella,
the pin rotating on the head from a first position where the pin is contained entirely in the shell to a second position projecting from the base;
a second closure element comprising a locking plate having an electromechanical anti-withdrawal means or a magnetic anti-withdrawal means; and
the first closure element and the second closure element being held together when the pin is inserted in the locking plate, an end of the pin being locked inside the locking plate by the respective anti-withdrawal means, the anti-withdrawal means being defeatable through a special magnetic device or a radio frequency device;
wherein the lamella comprises an engagement portion; and
wherein the head comprises
a first notch to engage with the engagement portion of the lamella to hold the pin in the first position, and
a second notch to with the engagement portion of the lamella to hold the pin in the second position.

8. An anti-shoplifting device to prevent theft of a product; the anti-shoplifting device comprising:
a first closure element comprising a shell, a head, and a pin,
the shell defining an interior space, the shell comprising a base, a lamella attached to the shell;
the pin projecting from the head, the pin for passing through the product,
the head comprises a head peg, the head being rotatably fitted to the base and being constrained by the lamella;
the pin rotating on the head from a first position where the pin is contained entirely in the shell to a second position projecting from the base;
a second closure element comprising a locking plate having an electromechanical anti-withdrawal means or a magnetic anti-withdrawal means; and
the first closure element and the second closure element being held together when the pin is inserted in the locking plate, an end of the pin being locked inside the locking plate by the respective anti-withdrawal means, the anti-withdrawal means being defeatable through a special magnetic device or a radio frequency device;
wherein the lamella comprises a fork shape and an engagement portion;
wherein the head comprises
a first notch to engage with the engagement portion of the lamella to hold the pin in the first position, and
a second notch to with the engagement portion of the lamella to hold the pin in the second position.

9. The anti-shoplifting device of claim 6, wherein the head cam comprises two walls.
